(19) United States
(12) Patent Application Publication
(10) Pub. No.: US 2020/0275063 A1
(43) Pub. Date: Aug. 27, 2020

(54) Method and Apparatus for Wildlife Monitoring

(71) Applicant: Martha Ann Zimet, Yerington, NV (US)

(72) Inventor: Martha Ann Zimet, Yerington, NV (US)

(21) Appl. No.: 16/501,166

(22) Filed: Feb. 27, 2019

(51) Int. Cl. H04N 7/18; H04N 5/225; H04N 5/232; H04R 1/02; H04R 3/00; A01M 31/00

(52) U.S. Cl. CPC H04N 7/188; H04N 5/2252; H04N 5/23203; H04N 5/23245; G10H 2250/321; H04R 3/00; H04N 7/183; A01M 31/002; A01M 31/004; H04R 1/028

(57) ABSTRACT

To monitor wildlife, including upland game birds, it is imperative to do so without human interaction and intervention, and therefore requires monitoring from a remote location. The embodiment of this invention described herein is an apparatus, contained in an environmentally impervious enclosure, to which consistent power is provided through solar radiation, a power management module is connected which conserves power to the apparatus, wildlife calls are selected through a human interface that operates in extreme environments, wildlife calls which beckon wildlife to the location are emitted periodically, wildlife behavior is visually recorded, and recorded images which detail movement are transmitted through wireless protocols. The specific site may have predator proof food and water or other such motivations for the wildlife to return to the site upon being called. With upland game birds, this may be a “rallying” call, specific to each game bird species. With other wildlife species, this could be a mating call, as an example.

### REFERENCE TO RELATED APPLICATIONS

This application claims an invention which was disclosed in Provisional Application No. 62/645,592 filed Mar. 23, 2018, entitled “User Selectable Solar Powered Wild Game Bird Recall Apparatus”. The benefit under 35 USC § 119(e) of the United States provisional application is hereby claimed, and the aforementioned application is hereby incorporated herein by reference.

### BACKGROUND

### Description of Related Art

Wildlife observation cameras are well understood as a mechanism to monitor wildlife. When positioned in remote areas, they operate randomly. That is, occasionally wildlife move into the camera range and trigger available motion sensors, but there is no motivation for the wildlife to come into the camera area.

An object of some embodiments of said cameras is to minimize power consumption by providing a camera sleep mode which could be interrupted by a sensor, such as a motion detector, or temperature sensor.

Another object of some embodiments is to provide a camera with a portable memory device that can be selectively attached to the camera and a computing device and manually carried between them for transferring digital images from the camera to the computing device.

Solar power is also well understood, whereby solar radiation is converted directly into electricity by solar cells (photovoltaic cells). In such cells, a small electric voltage is generated when light strikes the junction between a metal and a semiconductor (such as silicon) or the junction between two different semiconductors.

General packet radio service (GPRS) is also well understood and may be used to transmit events generated from remote sensors. Other transmission technologies such as Bluetooth and Wireless LAN (WLAN) are limited in their transmission distance, require clear line of sight, and therefore, are not useful for electronic devices in extremely remote locales.

Capacitive sensing as applied to user interfaces is also well understood technology. Based on capacitive coupling, sensors can detect and measure conductive objects that are dielectricly different from air.

Algorithms for image compression, and background subtraction are also well understood.

Environmentally impervious enclosures with high Ingress Protection (IP) ratings are also well understood.

One or more of these and/or other objects are provided by the subject invention.

### Technical Field of the Invention

An example embodiment of the present invention relates generally to the to the field of wildlife monitoring in remote locales. Specifically, the invention pertains to methods and apparatus for monitoring without human hand-print.

### BRIEF SUMMARY OF THE INVENTION

When monitoring wildlife, it is imperative to do so without human hand prints, that is, without any human interaction. This includes captive raised animals that are released to the wild as part of re-population projects. Captive raised upland game birds such as quail, partridge, pheasant, etc. are often re-populated due to their decline in the wild. Successful adaption of such game birds to the wild requires predator proof food and water, and an environmentally impervious electronic apparatus which provides the periodic emitting of species-specific “rallying” call, motion detecting camera, transmittal of captured images, all without human interaction and involvement which interfere with the birds' adaptation to the wild. Monitoring of upland game birds is one embodiment, however, the apparatus described herein is applicable to the monitoring of any wildlife species. Predator proof food and water is outside the scope of the disclosure herein.

### BRIEF DESCRIPTION OF THE DRAWINGS

Having thus described an example embodiment of the invention in general terms, reference will now be made to the accompanying drawings, which are not necessarily drawn to scale, and wherein:

FIG. 1 is block diagram of an apparatus that may be specifically programmed in accordance with an example embodiment of the present invention;

FIG. 2 is a flowchart of the central processor and motion camera that may be specifically programmed in accordance with the apparatus of the example embodiment of the present invention;

FIG. 3 is a block diagram of motion detecting that occurs in the central processor.

FIG. 4 is a presentation of an image with motion detected and highlighted; and

FIG. 5 is a flowchart of a human interface that may be specifically configured in accordance with the apparatus of the example embodiment of the present invention.

### DETAILED DESCRIPTION OF THE INVENTION

An embodiment of the present invention will now be described more fully hereinafter with reference to the accompanying drawings, in which one of the embodiments of the invention is shown. Indeed, various embodiments of the invention may be embodied in many different forms and should not be construed as limited to the embodiment set forth herein; rather, this embodiment is provided so that this disclosure will satisfy applicable legal requirements. Like reference numerals refer to like elements throughout. Although specific terms are employed herein, they are used in a generic and descriptive sense only and not for purposes of limitation.

Additionally, as used herein, the term ‘programmed’ refers to (a) combinations of electrical circuits and computer program object(s) comprising software and/or firmware instructions stored on one or more computer readable memories that work together to cause an apparatus to perform one or more functions described herein; (b) computer program object(s). This definition of ‘programmed’ applies to all uses of this term herein, including in any claims. As a further example, as used herein, the term ‘programmed’ also includes an implementation comprising one or more processors and/or portion(s) thereof and accompanying software and/or firmware.

Accordingly, it is to be understood that the embodiment of the invention herein described is merely illustrative of the application of the principles of the invention. Reference herein to details of the illustrated embodiment is not intended to limit the scope of the claims, which themselves recite those features regarded as essential to the invention.

Although specific terms are employed herein, they are used in a generic and descriptive sense only and not for purposes of limitation.

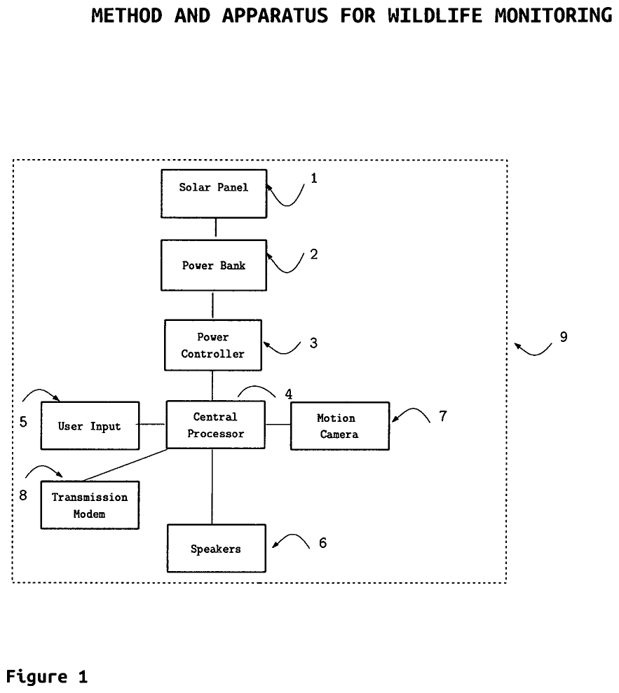

As shown in FIG. 1, the apparatus 9 as an example embodiment may consist of eight components, in which the solar panel 1 converts solar radiation directly into electricity which is stored in the power bank 2. The power bank provides electrical power to a power controller 3. The power controller 3 manages power to a central processor 4 which subsequently executes programmed events at specific, predefined times with predefined duration. For example, if an intention of the apparatus is to beckon wildlife such as upland game birds to a reliable source of food and water, their survival requires that such beckoning only be done during daylight hours. The user input 5 provides selection of wildlife species. The speakers 6 output recorded wildlife calls. The camera with motion sensor 7 is controlled by the central processor 4, and relays video image streams to the central processor 4. The central processor further processes the stream of video images, and detected motion may be stored in non-volatile memory on the central processor 4 in a standard image file format or transmitted remotely or both. The transmission modem 8 is controlled by the central processor 4, and transmits compressed images over wireless communication lines. Components of the apparatus 9, except for the solar panel 1 and speakers 6 are contained within in an environmentally impervious enclosure with an Ingress Protection (IP) rating of IP65 or higher.

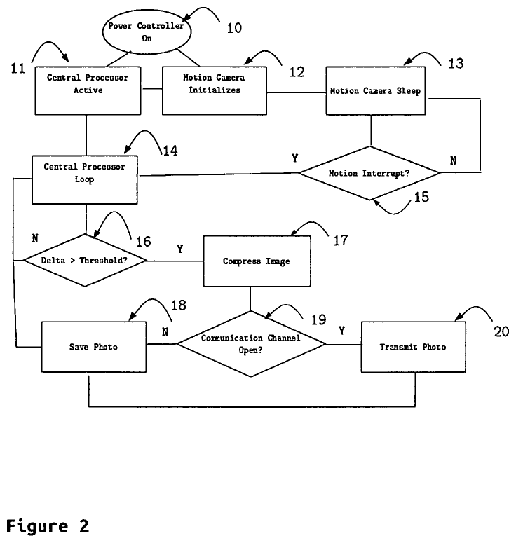

Continuing with FIG. 2, when the On state becomes active in the power controller 10 as a result of a previously programmed event, the central processor 11 powers on and its resident code for booting is loaded. In turn, any components connected to the central processor 11 initialize including the camera containing a motion sensor 12, hereinafter referred to as the “motion camera.” The central processor executes a loop that can be interrupted by any of the connected components 14. The motion camera 12 remains in a dormant, or sleep, mode 13 until such time as it receives an interrupt signal that motion has been detected by the sensor 15. Motion detection is calculated over a range of sequential video frames from the motion camera by the central processor 11. When the delta between two sequential video frames is greater than a configured threshold 16, the central processor compresses the image 17. Otherwise, the central processor resumes its loop awaiting input from connected components 14. Upon compresses the image 17 the central processor determines if the wireless communication channel is open with both the sending and receiving endpoints operational 19. When those conditions are true, the central processor transmits the compressed image 20, saves the compressed image to resident storage associated with the central processor 18, and finally returns to its main loop 14. Otherwise, the central processor saves the compressed image to resident storage associated with the central processor 18, and finally returns to its main loop 14.

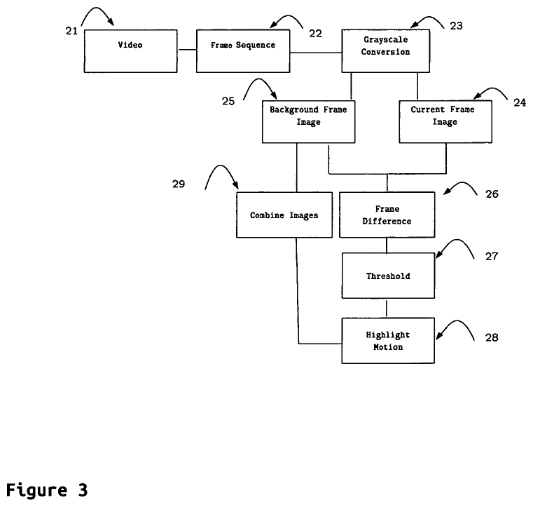

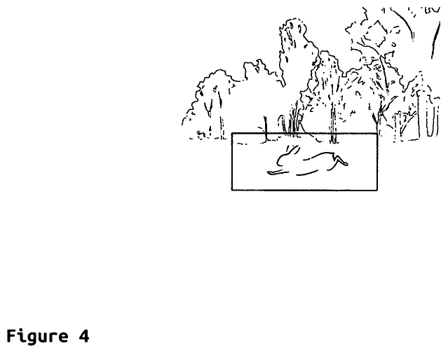

Continuing with FIG. 3, a block diagram of the motion detection process in the central processor 18, the central processor receives a sequential stream of video frames from the motion detecting camera 21. The number of frames making up a single frame sequence is a configuration parameter in central processor 22. For processing, the frames in the sequence are converted to grayscale 23, in which grayscale refers to the range of monochromatic shades, ranging from white to black, and the color specification only contains luminance information. The frame difference 26, or delta, is calculated between the current frame image 24 and the background frame image 25. The threshold 27 is a configuration parameter in the central processor which determines the number of changed pixels in the frame difference to declare motion. The threshold is applied to the frame difference 26. The motion detected is highlighted in the frame image 28. Finally, updating the background is achieved by morphing the background toward the current frame image 29, whereby morphing is a technique for the metamorphosis from one image to another. A representational image of the motion detection process previously declared is in FIG. 4.

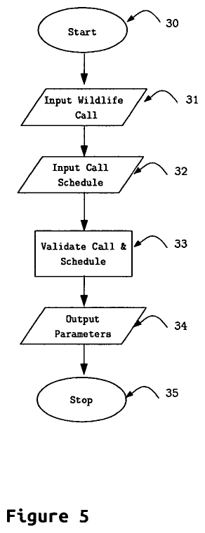

Concluding with FIG. 5, a flowchart of the human input mechanism on the apparatus 9 to select wildlife calls, a wildlife call is selected 31 from available options, followed by the call schedule 32 also from available options. Both selections are in turn validated 33, and finally the selection parameters are output 34 to the apparatus 9 through methods of nonvolatile storage.

What is claimed is:

1. An apparatus for wildlife monitoring, which may be enclosed in an environmentally impervious enclosure, comprising:
a solar panel; a power bank charged by the solar panel; a power controller receiving electrical power from the charged power bank; a central processor receiving managed power from the power bank; a capacitive sensor connected to the central processor, wherein the central processor is programmed to accept input from the sensor; a camera containing a motion sensor connected to the central processor, wherein the central processor is programmed to receive input from the motion sensor; a speaker connected to the central processor, wherein the speaker receives audio output from the central processor; a wireless transmission modem, wherein the central processor is programmed to send and receive data packets over the modem.

2. The power controller of claim 1 with two states: On and Off, and remaining in the Off state except for programmed time and duration intervals; whereby In the On state, the power controller provides power to the central processor; whereby in the Off state, the power controller does not provide power to the central processor; and whereby the central processor and its connected components are only active in the power controller On state.

3. The power controller of claim 3 may contain a real time clock operated by its own internal power bank, separate from the apparatus power bank, so that the real time clock runs when the power controller is in the Off state. The real time clock may synchronize with a network based time protocol immediately after the On state initializes, and when the wireless transmission modem is active to send and receive data packets.

4. The apparatus of claim 1 may contain a plurality of sensors including a capacitive sensor which may relay input to the central processor when a conductive object comes into close proximity to the sensor surface; and whereby the conductive object may be a stylus, gloved finger, or similar object.

5. The apparatus of claim 1, further comprising a wildlife call, wherein the central processor is programmed to activate the wildlife call based on input from claim 4 to allow the support of a plurality of wildlife calls.

6. The apparatus of claim 1, further comprising a schedule wherein the central processor is programmed to schedule audio output of wildlife calls based on input from claim 4 to allow the support of a plurality of schedules.

7. The central processor of claim 1, further compromising a queue of events, whereby when the power controller is in the On state, programmed events resident on the central processor are executed in a loop until such time as the power controller is in the Off state; and whereby such events may include audio output of wildlife calls and operations of the camera with motion sensor.

8. The central processor of claim 1 whereby wildlife images may be detected from motion, further collected, compressed and transmitted; whereby all automatic operations of the central processor are tuned for reduced power consumption and power endurance appropriate for an apparatus in remote locales in an environmentally impervious enclosure; and whereby wireless channel bandwidths transmitting data are thus constrained.
